(19) United States
(12) Patent Application Publication
(10) Pub. No.: US 2006/0272160 A1
(43) Pub. Date: Dec. 7, 2006

(54) Hairdressing scissors and connecting member thereof

(76) Inventor: Wen-Ya Yeh, Tainan City (TW)

Correspondence Address: PRO-TECHTOR INTERNATIONAL SERVICES, 20775 NORADA CT., SARATOGA, CA, 95070, US

(21) Appl. No.: 11/144,532

(22) Filed: Jun. 3, 2005

(51) Int. Cl. B26B 13/00

(52) U.S. Cl. 30/226

(57) ABSTRACT

A pair of hairdressing scissors includes of a first blade and a second blade. At the end of the first and second blades and are disposed handle portions each has an opening for the thumb or index finger of the user. The first and second blades are pivotally connected through a pivot. A connecting member includes a female block and a male block that are disposed at two opposite sides of at least one of the first and second blades, by inserting the projection of the female block into the notch of the groove of the male block, the female block will be engaged with the male block, and thus a plural pairs of hairdressing scissors will be engaged one another.

### BACKGROUND OF THE INVENTION

1. Field of the Invention

The present invention relates to a pair of hairdressing scissors and the connecting member thereof, and more particularly to a pair of hairdressing scissors having connecting member defined on the handle portion thereof, so that plural pairs of such hairdressing scissors can be detachably engaged together.

2. Description of the Prior Arts

A hairstylist cuts a customer's hair with several techniques, including trimming, thinning, layering, etc. Sometimes the hairstylist has to hold plural pairs of scissors in the same hand for proceeding with the thinning or layering of the hair to obtain the desired special hairstyle.

During operation of the plural pairs of scissors in the same hand, the user must keep the plural pairs of scissors be spaced at regular intervals and operate them with the same operating condition. The plural pairs of scissors must open and close synchronously to obtain a tidy, beautiful hairstyle. However, the plural pairs of scissors are simply held by the index finger and the thumb of the user such that the plural pairs of scissors cannot be operated synchronously due to touchy control of the plural pairs of scissors by the fingers. Thus, the plural pairs of scissors often become skew to one another and the spacing therebetween may be different from one another. The haircutting result is adversely affected, and this problem is aggravated if the user is inexperienced. The user often feels pain when operating the plural pairs of scissors in addition to numerous limitations to and difficulties in operation.

U.S. Pat. Nos. 6,192,590 B1, 6,434,833 B1 and 6,634,106 B2 disclose hairdressing scissor assemblies to solve the above-mentioned problems. These hairdressing scissor assemblies can be detachably engaged together so as to allow the hairstylist to use them as freely and easily as using one hairdressing scissor assembly.

The present invention has arisen to mitigate and/or obviate the afore-described disadvantages.

### SUMMARY OF THE INVENTION

The primary objective of the present invention is to provide a pair of hairdressing scissors having connecting member defined on the handle portion thereof, so that plural pairs of such hairdressing scissors can be detachably engaged together.

A pair of hairdressing scissors provided in accordance with the present invention comprises:

a first blade pivotally connected to a second blade;

a connecting member disposed at least one of the first and second blades, including a female block defined with a concave portion and a male block employed to be engaged in the concave portion, in the concave portion being formed a socket and a projection, and a notch is located beside the groove of the male block for mating with the projection of the female block. The male block is defined with a groove for mating with the projection, the female block and the male block are disposed at two opposite sides of at least one of the first and second blades, by inserting the projection of the female block into the groove of the male block, the female block will be engaged with the male block, and thus a plural pairs of hairdressing scissors will be engaged one another.

The thickness of the female block is greater than the depth of the through hole, so that the female block and the male block will project out of two opposite sides of at least one of the first and second blades. Or, the thickness of the female block is equal to the depth of the through hole, so that the male block will project out of a side of at least one of the first and second blades and the female block will flush with another side of at least one of the first and second blades.

The female block can be integral with or separated from the male block.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a pair of hairdressing scissors in accordance with a first embodiment of the present invention;

FIG. 2 is a perspective view of two pairs of hairdressing scissors in accordance with the present invention;

FIG. 3 is a cross sectional view of the two pairs of hairdressing scissors in FIG. 2;

FIG. 4 is a cross sectional view of showing three pairs of hairdressing scissors in accordance with the first embodiment of the present invention are being engaged with one another;

FIG. 5 is a perspective view of a pair of hairdressing scissors in accordance with a second embodiment of the present invention;

FIG. 6 is a perspective view of two pairs of hairdressing scissors in accordance with the second embodiment of the present invention;

FIG. 7 is a cross sectional view of the two pairs of hairdressing scissors in FIG. 6;

FIG. 8 is a cross sectional view of showing three pairs of hairdressing scissors in accordance with the second embodiment of the present invention are being engaged with one another;

FIG. 9 is a perspective view of a pair of hairdressing scissors in accordance with a third embodiment of the present invention;

FIG. 10 is a perspective view of two pairs of hairdressing scissors in accordance with the third embodiment of the present invention;

FIG. 11 is a cross sectional view of the two pairs of hairdressing scissors in FIG. 10; and

FIG. 12 is a cross sectional view of showing three pairs of hairdressing scissors in accordance with the third embodiment of the present invention are being engaged with one another.

### DETAILED DESCRIPTION OF THE PREFERRED EMBODIMENTS

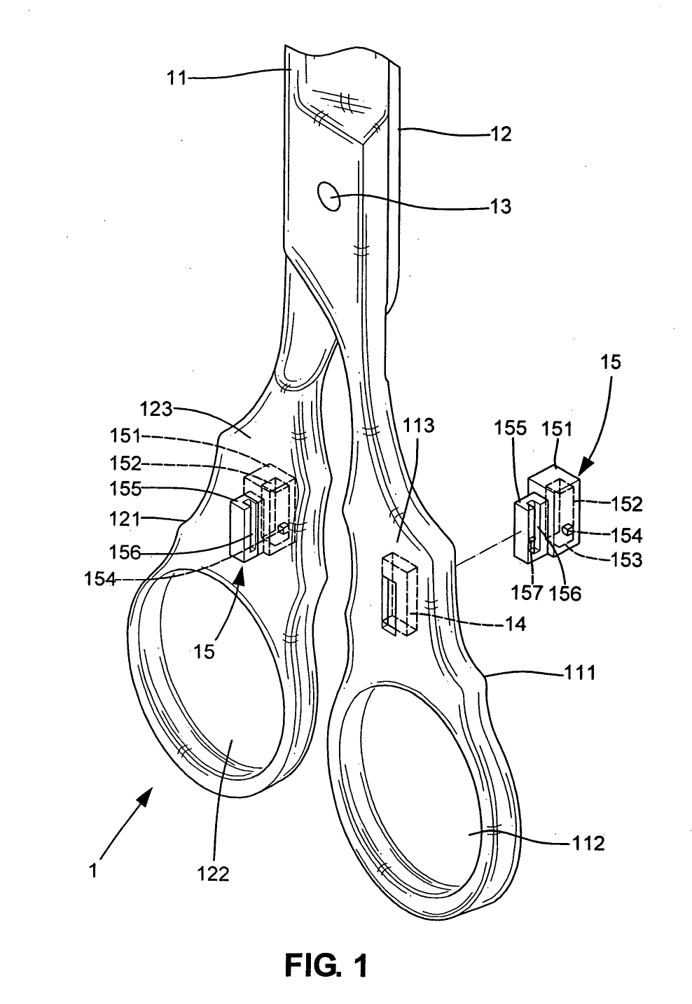

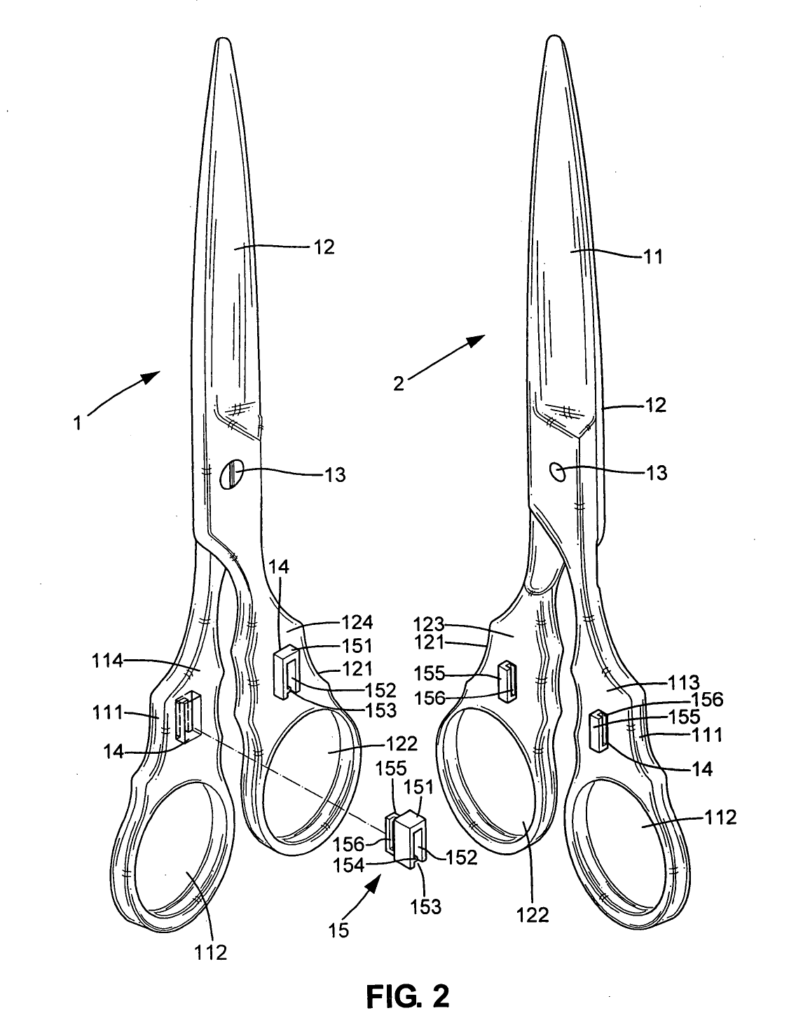

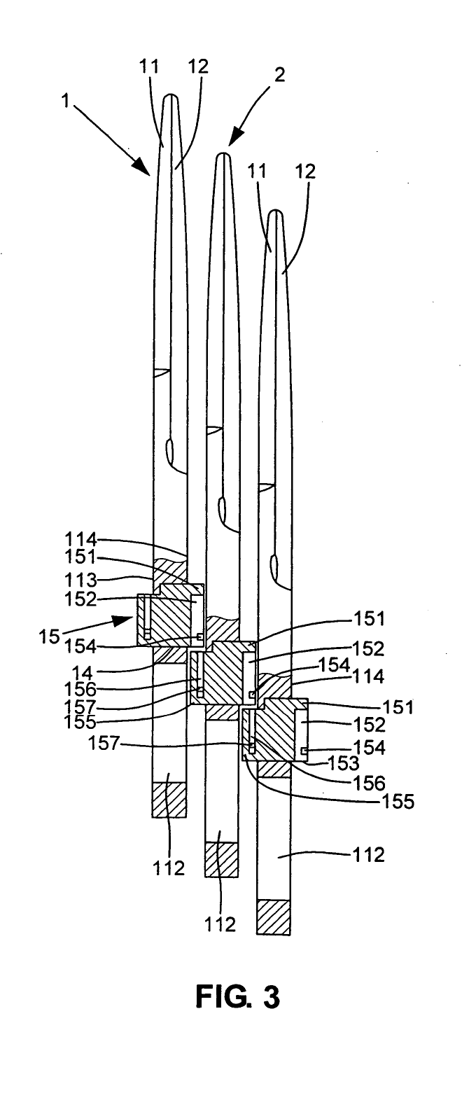

FIG. 1 is a perspective view of a pair of hairdressing scissors in accordance with a first embodiment of the present invention. FIG. 2 is a perspective view of two pairs of hairdressing scissors in accordance with the present invention. FIG. 3 is a cross sectional view of two pairs of hairdressing scissors in FIG. 2. The first pair of hairdressing scissors 1 and the second pair of hairdressing scissors 2 each include a first blade 11 and a second blade 12. At the end of the first and second blades 11 and 12 are disposed handle portions 111 and 121 each has an opening 112 and 122 for the thumb or index finger of the user. The first and second blades 11 and 12 are pivotally connected through a pivot 13.

The handle portions 111 and 121 each includes a first side 113 and 123 vertical to the opening and closing direction of the hairdressing scissors and a second side 114 and 124 located opposite to the first side 113 and 123. At least one of the handle portions 111 and 121 is defined with a through hole 14 running through the first sides 113 and 123 and the second side 114 and 124, in the through hole 14 is received a connecting member 15. In this embodiment, both of the handle portions 111 and 121 are defined with a through hole 14 for reception of a connecting member 15.

The connecting member 15 includes a female block 151 that is to be inserted and positioned in the through hole 14, and the female block 151 is formed at a side thereof with a concave portion 152 and a male block 155 located at another side thereof opposite to the concave portion 152. The male block 155 and the concave portion 152 have congruent perimeter so that the male block 155 can be engaged with the concave portion 152. In application, the thickness of the female block 151 is larger than the depth of the hole 14, so that the male block 155 and the female block 151 will protrude out of the first side 113 and 123 and the second side 114 and 124 of the handle portions 111 and 121 after the connecting member 15 is received in the hole 14, as shown in FIG. 3.

In the concave portion 152 are further formed a socket 153 and a projection 154, on the male block 155 is defined a groove 156 for mating with the projection 154, and in the groove 156 is formed a stop point 157, so that the first and second pair of hairdressing scissors 1 and 2 can be engaged together conveniently, as shown in FIG. 3.

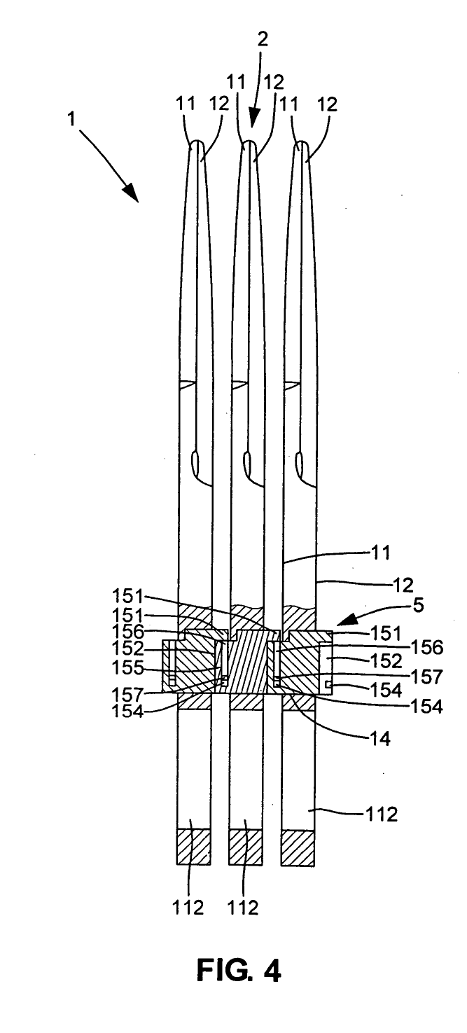

Referring to FIGS. 3 and 4, when the male block 155 on the first side 113 of the second pair of hairdressing scissors 2 engages in the concave portion 152 on the second side 114 of the first pair of hairdressing scissors 1 via the socket 153, the projection 154 will be moveably engaged in the groove 156, so that the two pairs of hairdressing scissors can be assembled together easily. Meanwhile, the stop point 157 will be locked with the projection 154 for strengthening the engagement between the two pairs of hairdressing scissors. Through the engagement of the male block 155 with the female block 151, a plural pairs of hairdressing scissors can be engaged together, as shown in FIG. 4.

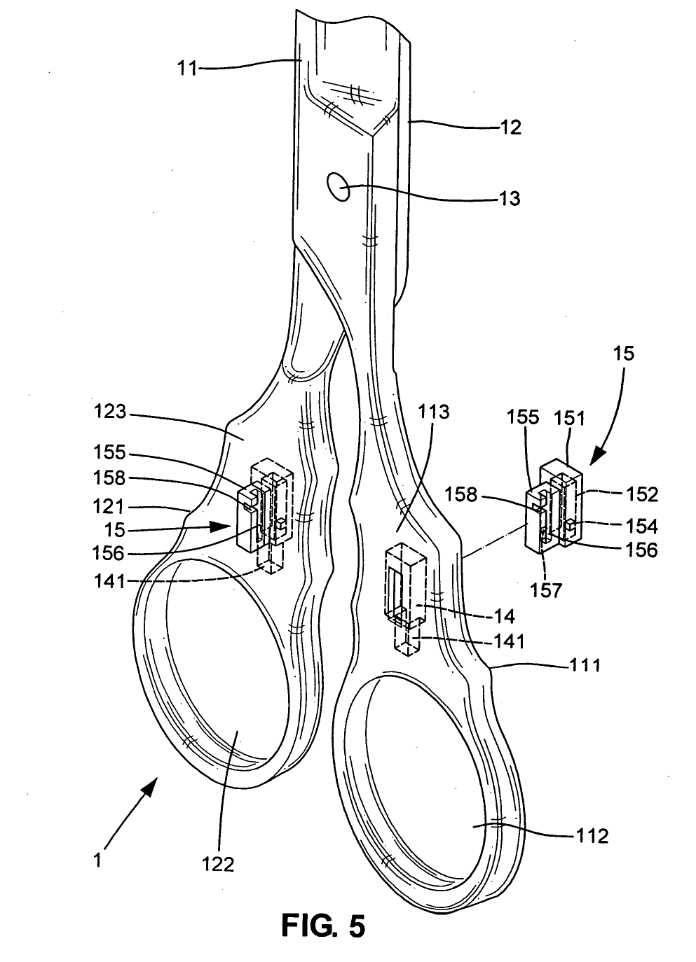

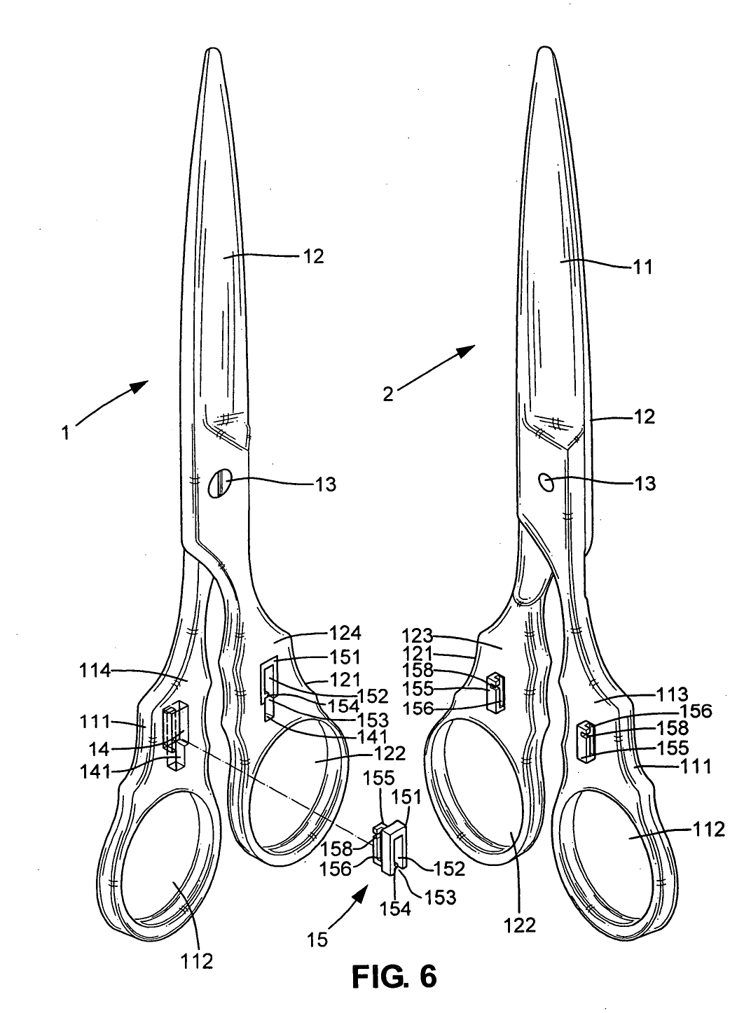

The intervals between the hairdressing scissors can be modified according to the hairdressing scissors and the thickness of the handle portion thereof. With reference to FIGS. 5-7, which show the hairdressing scissor assembly in accordance with a second embodiment of the present invention (the structures or components in this embodiment equivalent or similar to that of the first embodiment will be designated by the same reference number). The thickness of the female block 151 is equal to the depth of the hole 14, after the connecting member 15 is received in the hole 14, only a part of the male block 155 projects out of the first sides 113 and 123 of the handle portions 111 and 121, while the concave portion 152 of the female block 151 doesn't project out of the second sides 114 and 124. In this embodiment, the surface of the female block 151 having the concave portion 152 flushes with the second sides 114 and 124 of the handle portions 111 and 121, as shown in FIG. 6.

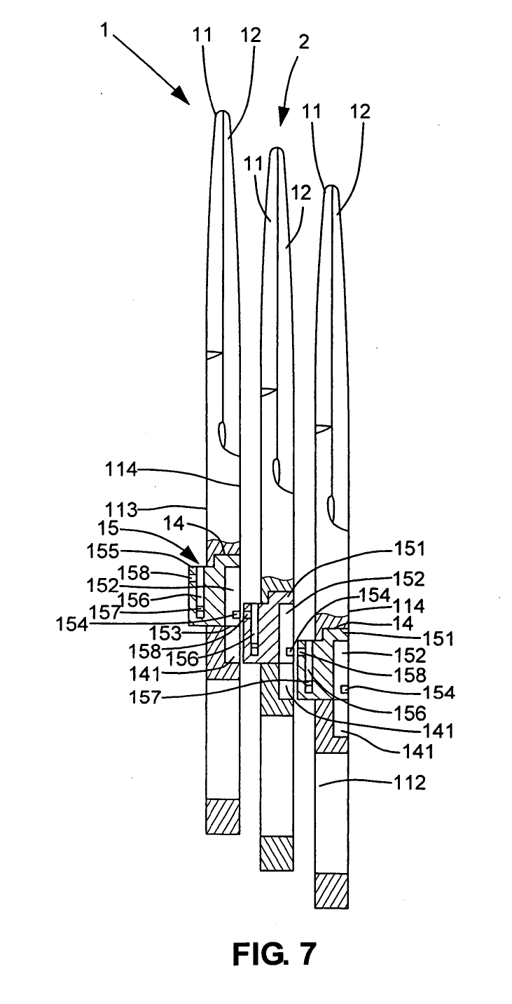

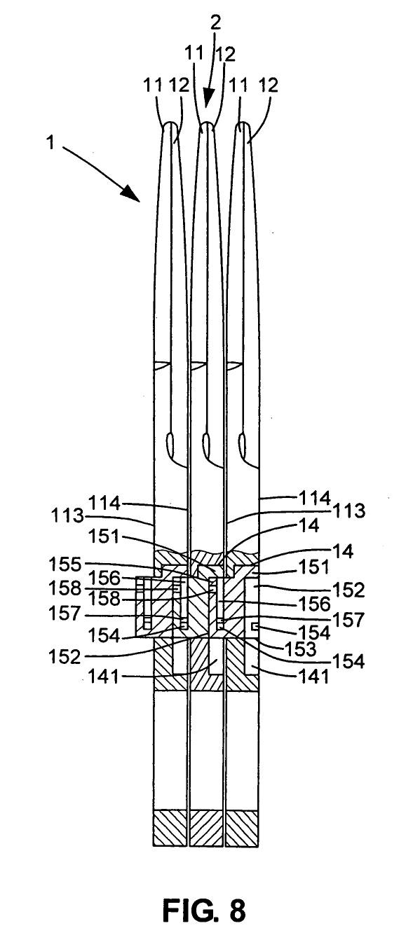

Adjacent to an end of the hole 14 is defined a cavity 141 in communication with the socket 153, and a notch 158 is formed beside the groove 156 of the male block 155. Therefore, as shown in FIG. 7, the male block 155 of the second pair of hairdressing scissors 2 also can be engaged in the concave 152 of the first pair of hairdressing scissors 1 via the cavity 141, meanwhile, the stop point 157 will be locked with the projection 154 for strengthening the engagement between the two pairs of hairdressing scissors, and thus the plural pairs of hairdressing scissors can be engaged one another at a small interval, as shown in FIG. 8.

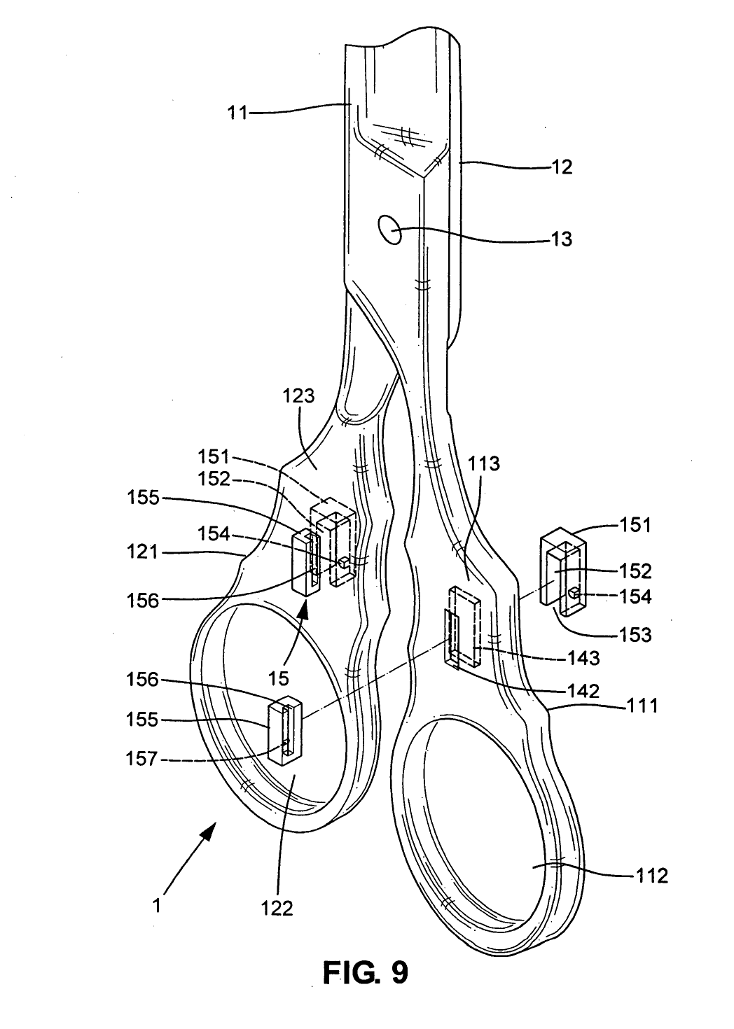

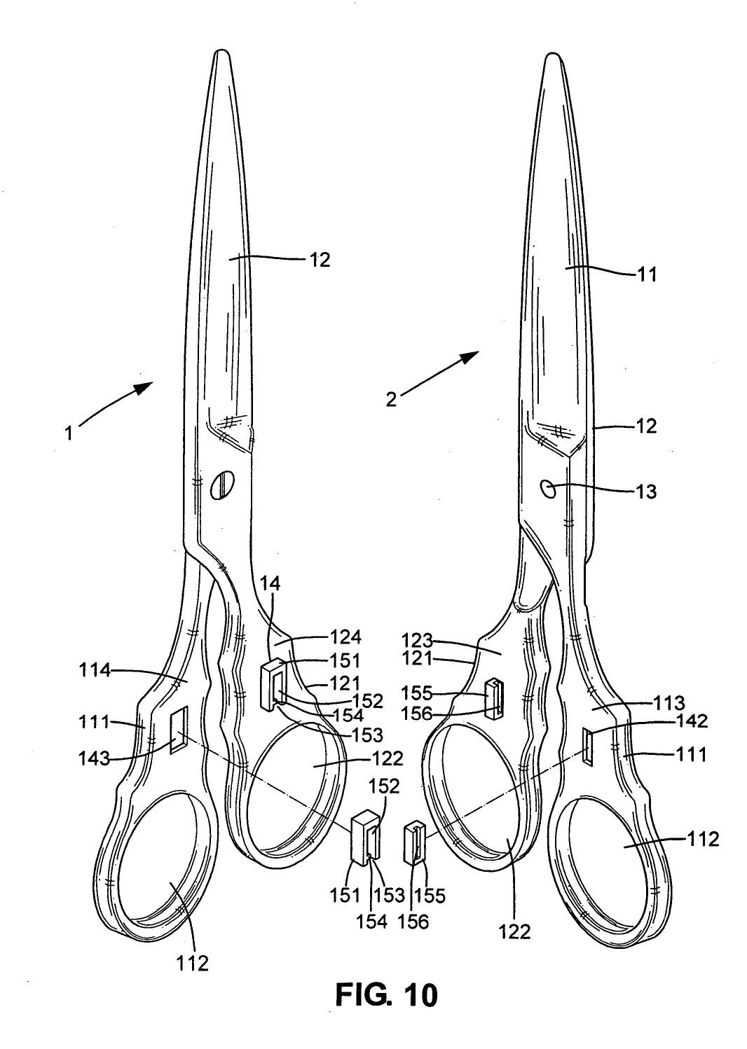

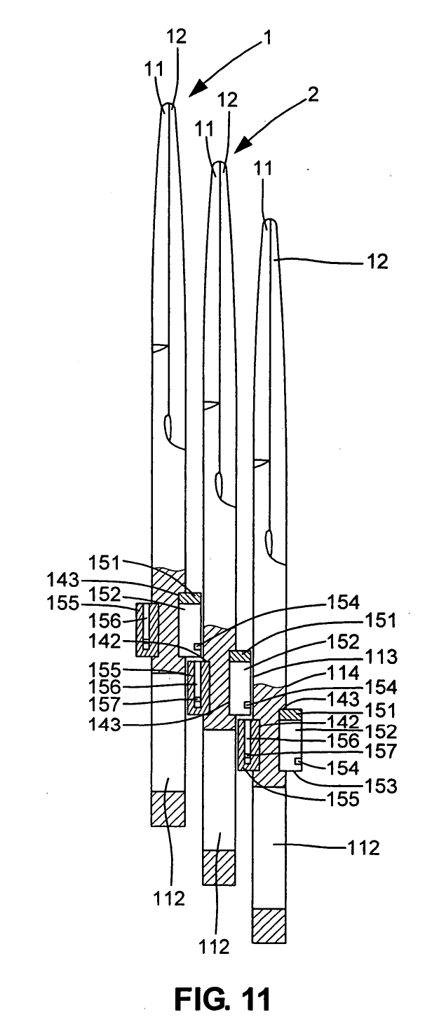

Referring to FIGS. 9-11, which show the hairdressing scissor assembly in accordance with a second embodiment of the present invention (the structures or components in this embodiment equivalent or similar to that of the first embodiment will be designated by the same reference number), wherein the female and male blocks 151 and 155 of the connecting member 15 are separated. The hole 14 for receiving the connecting member 15 is replaced and composed by the cavity 142 on the first sides 113 and 123 and the cavity 143 on the second sides 114 and 124. The male block 155 is received in the cavity 142 and projects out of the first sides 113 and 123, and the female block 151 is accommodated in the cavity 143 and partially projects out the second sides 114 and 124, as shown in FIG. 11.

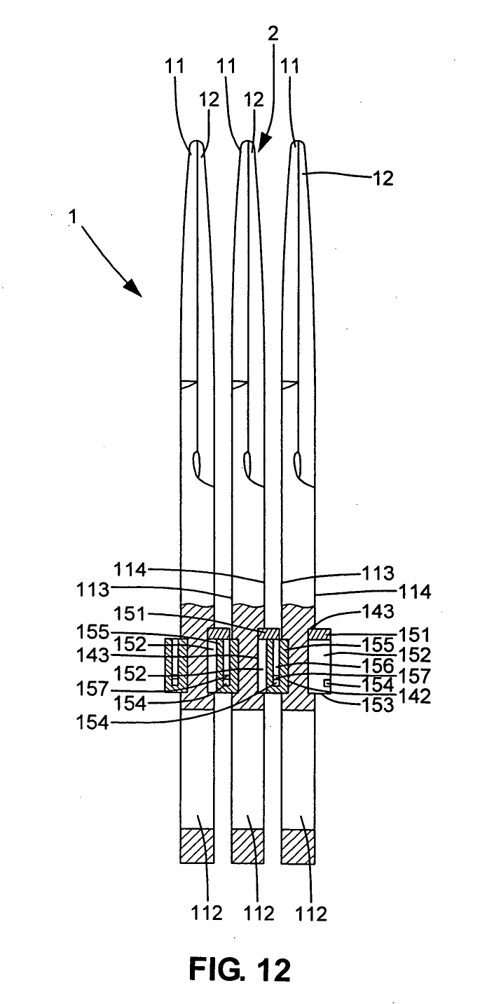

By inserting the male block 155 of the second pair of hairdressing scissors 2 as shown in FIG. 11 in the concave portion 152 of the first pair of hairdressing scissors 1 through the socket 153, a plural pairs of hairdressing scissors can be engaged one another subsequently, as shown in FIG. 12.

While we have shown and described various embodiments in accordance with the present invention, it should be clear to those skilled in the art that further embodiments may be made without departing from the scope of the present invention.

What is claimed is:

1. A pair of hairdressing scissors comprising:
a first blade pivotally connected to a second blade; and
a connecting member disposed at least one of the first and second blades, including a female block defined with a concave portion and a male block employed to be engaged in the concave portion, in the concave portion being formed a socket and a projection, wherein the male block is defined with a groove for mating with the projection, the female block and the male block are disposed at two opposite sides of at least one of the first and second blades, by inserting the projection of the female block into the groove of the male block, the female block will be engaged with the male block, and thus a plural pairs of hairdressing scissors will be engaged one another.

2. The pair of hairdressing scissors as claimed in claim 1, wherein a through hole for reception of the connecting member is formed on at least one of the first and second blades.

3. The pair of hairdressing scissors as claimed in claim 2, wherein a thickness of the female block is greater than a depth of the through hole, so that the female block and the male block will project out of two opposite sides of at least one of the first and second blades.

4. The pair of hairdressing scissors as claimed in claim 1, wherein the female block is separated from the male block and are disposed at the two opposite sides of at least one of the first and second blades.

5. The pair of hairdressing scissors as claimed in claim 1 further comprising a stop point that is formed in the groove of the male block and to be locked with the projection of the female block.

6. A pair of hairdressing scissors comprising:
a first blade pivotally connected to a second blade; and
a connecting member including a female block defined with a concave portion and a male block employed to be engaged in the concave portion, in the concave portion being formed a socket and a projection, wherein the male block is defined with a groove for mating with the projection and a notch located beside the groove; and
a through hole for reception of the connecting member is formed on at least one of the first and second blades, the female block and the male block are disposed at two opposite sides of at least one of the first and second blades, and a cavity is formed adjacent to an end of the through hole and in communication with the socket of the concave portion of the female block;
by inserting the projection of the female block into the notch of the groove of the male block, the female block will be engaged with the male block, and thus a plural pairs of hairdressing scissors will be engaged one another.

7. The pair of hairdressing scissors as claimed in claim 6, wherein a thickness of the female block is equal to a depth of the through hole, so that the male block will project out of a side of at least one of the first and second blades and the female block will flush with another side of at least one of the first and second blades.

8. The pair of hairdressing scissors as claimed in claim 6 further comprising a stop point that is formed in the groove of the male block and to be locked with the projection of the female block.

9. A connecting member comprising a female block defined with a concave portion, in the concave portion being defined a socket and a projection; and
a male block formed with a groove for mating with the projection of the female block.

10. The connecting member as claimed in claim 9 further comprising a stop point that is formed in the groove of the male block and to be locked with the projection of the female block.

11. The connecting member as claimed in claim 9 further comprising a notch located beside the groove of the male block for mating with the projection of the female block.
